(19) United States
(12) Patent Application Publication
(10) Pub. No.: US 2006/0049280 A1
(43) Pub. Date: Mar. 9, 2006

(54) ROTARY COUPLER WITH BEARING LUBRICATION

(75) Inventors: Wallace G. Boelkins, Grand Rapids, MI (US); Jeffrey Coffey, Alto, MI (US)

Correspondence Address: MCGARRY BAIR PC, 171 MONROE AVENUE, N.W., SUITE 600, GRAND RAPIDS, MI, 49503, US

(73) Assignee: UNIST, INC., Grand Rapids, MI (US)

(21) Appl. No.: 11/162,343

(22) Filed: Sep. 7, 2005

Related U.S. Application Data
(60) Provisional application No. 60/522,249, filed on Sep. 7, 2004.

(51) Int. Cl. B05B 1/26

(52) U.S. Cl. 239/461

(57) ABSTRACT

A lubrication system for a rotary coupler comprises a rotary coupling configured to deliver fluid from an external fluid source through a rotating member mounted in a bearing and lubricating the bearing.

### CROSS-REFERENCE TO RELATED APPLICATION

This application claims the benefit of U.S. provisional application Ser. No. 60/522,249, filed Sep. 7, 2004, which is incorporated herein in its entirety.

### FIELD OF THE INVENTION

The invention relates to a controlled system for delivering metered quantities of lubricants and coolants, as needed, to machines and workpieces in manufacturing or other industrial operations. More particularly, the invention relates to the application of a lubricant to a rotary coupler.

### DESCRIPTION OF THE RELATED ART

In industrial operations, particularly in cutting and machining operations on hard materials such as metals, it is highly desirable to apply liquid lubricants or coolants to the cutting tools and/or workpieces, and often to the motors and bearings, slides, ball screws, and the like comprising the associated machinery, throughout duty cycles. Coolants are typically applied to the tool/workpiece interface to dissipate the heat generated by friction between the tool and workpiece, and generally comprise a high percentage of water. Lubricants are typically used to lubricate moving parts of the machinery, and are normally pure petroleum-based oils. To the extent that a coolant reduces the friction between a tool and a workpiece, coolants can also be considered lubricants. Conversely, to the extent that a lubricant dissipates heat, it can be considered a coolant. Quite often, the use of a lubricant or coolant performs some of the same functions as the other. Thus, the terms “coolant” and “lubricant” are often used interchangeably to refer to a fluid applied to a workpiece even though there are occasions where the distinction is important, such as great amounts of heat need to be generated a traditional coolant, such as a refrigerant, is applies to the tool/workpiece interface. Different processing operations involving tools and workpieces often have differing requirements for lubricants and coolants. Similarly, power tools and power motors have differing requirements for coolants and lubricants.

It is common, for example, to deliver a continuous stream of coolant to a tool during a machining operation on a workpiece. One of the natural consequences of this process is a need to recover the coolant, filter any scrap particles machined from the workpiece, and otherwise store or recycle the coolant. If the coolant is water-based, it may include an oil concentrate so that the resulting coolant-coated scrap particles must be cleaned and the fluid disposed of according to the requirements of hazardous waste disposal. Recycling of coolant and disposal of waste is very costly.

It is also known to apply lubricants and coolants in mist or “atomized” form by, for example, spraying from an appropriate nozzle a mixture of air and lubrication/coolant. When applied in mist form, a comparable amount of fluid can cover a larger surface area of the target object than when it is applied as a stream, thus adding efficiency and economy to the lubricating/cooling process. Typically, the fluid is a light, non-petroleum oil that is delivered under pressure and combined with air at a nozzle to be sprayed on the workpiece. These are frequently referred to as “near dry” lubricant systems.

Normally, because of the wide variety of machines, workstations, and processes, and their disparate requirements for delivery of coolants and lubricants, delivery systems are provided at the workstation, and controlled by the workstation. Such mechanisms can be found in U.S. Pat. Nos. 5,669,743, 5,542,498 and 6,213,412, all of which are incorporated herein by reference.

Operations on a workpiece frequently involve drilling or tapping utilizing a rotating cutting tool. The cutting tool is held in a rotating spindle. The lubricant/coolant is often delivered to the cutting tool and the workpiece through the spindle from a reservoir. In a near dry lubricant system, both the reservoir and air supply must be fluidly connected to the rotating spindle, typically through air and lubricant supply lines. The air and lubricant supply lines rotate and must be supplied by stationary conduits. A rotary coupling is used to fluidly connect the stationary conduits with the rotating spindle. This typically comprises a shaft that rotates within a stationary housing.

The supply lines are attached to the rotary coupling. The rotary coupling is provided with channels for delivering the air and lubricant through the shaft and the spindle to the workpiece and cutting tool. The rotary coupling is comprised of bearings between the rotating shaft and the stationary rotary coupling housing, which must be lubricated from time-to-time as required by the manufacturer's maintenance cycle. Often, the bearings are lubricated only at the factory with grease. Since there is no way to reapply grease, the rotary coupling will prematurely fail leading to an unexpected downtime for the tooling machine. The machine downtime and coupling replacement are very costly.

There is a need for a reliable and efficient system which can deliver coolants and lubricants to a rotary coupling as well as supply coolants/lubricants to the cutting tool/workpiece interface.

### SUMMARY OF THE INVENTION

In one aspect the invention relates to a rotary coupling comprises a housing defining a bearing chamber, a shaft having a portion located in the bearing chamber and an internal lubricant passageway having an inlet and an outlet, with the inlet configured to receive a lubricant that is expelled through the outlet; a bearing located within the bearing chamber and disposed between the housing and the shaft to rotatably mount the shaft to the housing, and a lubricant inlet in the housing and fluidly coupled to the bearing chamber whereby an externally located lubricant can be supplied to the bearing.

In another aspect the invention relates to a lubrication system comprises a rotary coupling comprising a housing and a rotating member supported by a bearing in the housing, and configured to deliver fluid from an external fluid source through the rotating member, and a lubricant supply external of the rotary coupling and fluidly coupled to the bearing for delivering a lubricant to the bearing.

In yet another aspect the invention relates to a method for lubricating a rotary coupling comprising a housing defining a bearing chamber, a shaft having a portion located in the bearing chamber, and a bearing located within the bearing chamber and disposed between the housing and the shaft to rotatably mount the shaft to the housing, comprises lubricating the bearing while the shaft is rotated.

### BRIEF DESCRIPTION OF THE DRAWINGS

In the drawings:

FIG. 1 is a schematic diagram illustrating a first embodiment of a rotary coupling with a through spindle and bearing lubrication system according to the invention.

FIG. 2 is a sectional view through the rotary coupling illustrated in FIG. 1 showing a through spindle lubrication assembly and a bearing lubrication assembly.

FIG. 2A is an end view of the rotary coupling of FIG. 2.

FIG. 3 is an exploded view of a tube assembly comprising a portion of the through spindle lubrication assembly illustrated in FIG. 2.

FIGS. 4A and 4B are side elevation and front elevation views, respectively, of an air separator comprising a portion of the tube assembly illustrated in FIG. 3.

FIG. 5 is a schematic diagram illustrating a second embodiment of a rotary coupling with a through spindle and bearing lubrication system according to the invention.

### DETAILED DESCRIPTION

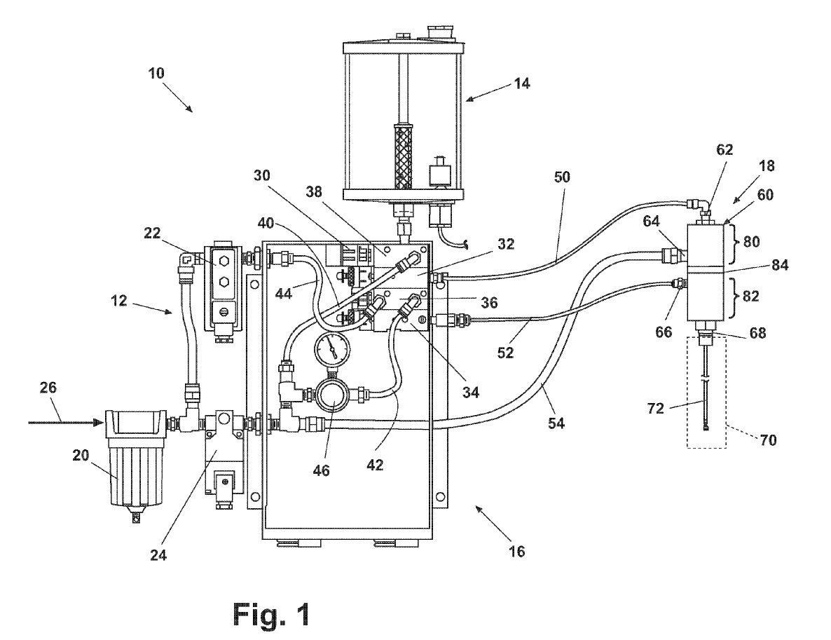

Referring now to the figures, and to FIG. 1 in particular, a first embodiment of a lubricant delivery system 10 according to the invention is illustrated. The lubricant delivery system 10 comprises an air delivery system 12, a lubricant reservoir 14, an air/lubricant metering system 16, and a tool assembly 18. The air/lubricant metering system 16 shares several elements of a pulse action mist lubrication system whose structure and operation are described in U.S. Pat. No. 5,542,498 to Boelkins, which is incorporated by reference as though set forth fully herein. The lubricant delivery system 10 also comprises several elements well-known to those in the cutting tool and machining arts, and such elements will not be described in detail herein except as otherwise necessary for a complete understanding of the invention.

For purposes of this description, the term lubricant will be used as meaning either or both a lubricant or coolant. While it is true that not all coolants are lubricants, in most applications relevant to this invention, the same substance can be used to perform the lubricating and cooling functions. Thus, for ease of description, the term lubricant will be used for both, with the understanding that it can include both coolants (essentially water) and lubricants (essentially oil). When a distinction between a lubricant and coolant is warranted it will be so noted.

The air delivery system 12 comprises an air filter/regulator 20, which is supplied pressurized air 26 from a suitable source (not shown), such as “shop” compressed air or an air compressor. Typically, shop compressed air is supplied at 60 to 120 psi. The output from the air filter 20 is fluidly coupled to both an electronic time delay valve 22, capable of a maximum delay of 45 minutes per cycle, and a well-known solenoid valve 24. The electronic time delay valve 22 is capable of opening and closing in response to a preselected timing sequence for delivery of pressurized air to the air/lubricant metering system 16. The electronic time delay valve 22 and the solenoid valve 24 are fluidly coupled to the air filter/regulator 20 in parallel to provide pressurized air to separate elements of the air/lubricant metering system 16.

The lubricant reservoir 14 holds a liquid lubricant for low-pressure feeding of the lubricant to the air/lubricant metering system 16. The lubricant reservoir 14 holds a suitable lubricant for the purposes described herein. While a lubricant, such as a petroleum-based or vegetable-based oil, can be used in either a liquid or near-dry form, a near-dry lubricant is best suited for the described application. The lubricant reservoir is fluidly coupled to the air/lubricant metering system 16.

The air/lubricant metering system 16 comprises multiple air-actuated injectors 32, 34 for dispensing lubricant from the reservoir to the tool assembly 18 separated by manifolds 38, 36 which contain the necessary air and lubricant passages for supplying air and lubricant as needed to the injectors 32, 34. Injectors 32, 34 of this type eject discrete metered volumes of fluid from a continuous supply in response to specific control actuation. Devices of this type are commonly referred to as “metering pumps” or “injection pumps” and are well-known in the art. The injector 32 comprises an injector (not shown) which comprises an in-line metering pin which moves through a closely-fitted chamber to eject a measured volume of fluid therefrom in response to an actuating force, which, in this case, is a pulse of pressurized air. A more detailed description of the injectors and their control is disclosed in U.S. Pat. Nos. 5,542,498 and 3,421,600, whose descriptions are incorporated by reference.

Air lines 40, 42 supply pressurized air to the manifold 38, 36 when the valve 24 is open. The air lines 40, 42 supply the air used to actuate the injectors 32, 34, respectively. An air line 44 supplies pressurized air to the manifold 36 when the valve 22 is open and functions to control the actuator of the injector 34.

An actuator 30 is used to control the actuation of the injector 32. The actuator 30 comprises a pulsatory control apparatus fluidly coupled through the fluid manifold 38 to the first injector 32. The pulsatory control apparatus 30 can comprise a pneumatic pulse generator whose basic function is to provide a sequence of recurring pulses of pressurized air, as supplied by air line 40, to the injector 32, in response to which the injector 32 provides a corresponding sequence of metered charges of lubricant through lubricant line 50 to the tool assembly 18. The pulsatory control apparatus 30 is described in further detail in U.S. Pat. No. 5,542,498. The pulsatory control apparatus 30 will normally cycle at from 6 to 20 cycles per minute.

The injector 34 is actuated by the flow of pressurized air from line 44, which is controlled by the electronic time delay valve 22. Thus, the electronic time delay valve 22 functions as the controller or actuator for the injector 34. It is within the scope of the invention for the injector 34 to be controlled using a pulsatory control like that used to control the injector 32. However, for the described embodiment, the frequency of actuation of the injector 34 will be much less than the injector 32. While the pulsatory control 30 can perform the lower frequency of actuation, the electronic time delay valve 22 is a more cost effective solution for the anticipated frequency of actuation for the injector 34.

The output of the injector 34 differs from that of the injector 32. Whereas the injector 32 ejects pulses of lubricant, the injector 34 very slowly ejects lubricant introduced into an air stream. The air supplied in air line 42 is continuously passed through the manifold 36 and into the second lubricant/air line 52. A separate pressure regulator 46 is provided on the air line 42 to provide for the independent control of the air pressure passing through the air line 42. The time delay valve 22 sends a pulse of air to the injector 34 that causes the injector to actuate and dispense a small volume of lubricant into the continuous air stream supplied to the injector from line 42. Thus, the output from the injector into the lubricant/air line 52 is a continuous stream of air with a periodic discharge of lubricant. The lubricant becomes entrained in the air steam and carried to bearings contained within the tool assembly 18.

Air line 54 extends from the solenoid valve 24 to the tool assembly 18. Thus, air is only supplied through the air line 54 when the valve 24 is open.

The tool assembly 18 is fluidly coupled to three pressurized fluid lines, the first line 50 containing lubricant, the second line 52 containing a mixture of pressurized air and lubricant, and the third line 54 containing pressurized air.

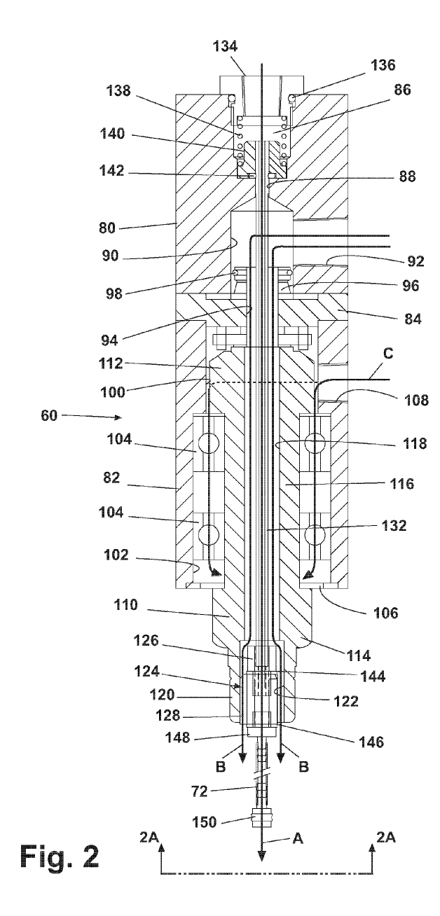

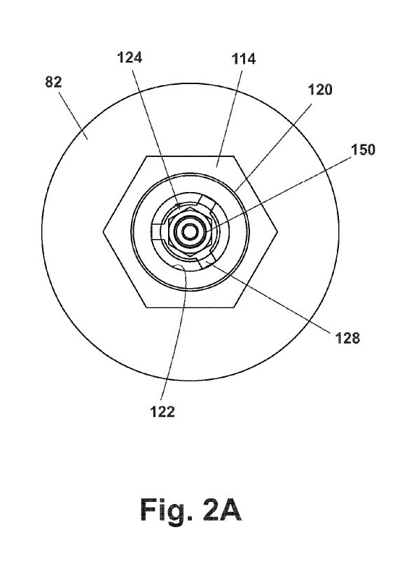

Referring to FIGS. 1 and 2, the tool assembly 18 comprises a rotary coupling 60 operatively connected to a spindle 70 of a tooling machine (shown schematically in phantom in FIG. 1) adapted for holding a cutting tool (not shown). The rotary coupling 60 comprises an adapter body 80 and a bearing housing 82, which are separated by an intermediate plate 84, and a shaft 110 extending from and rotatably mounted within the bearing housing 82. The adapter body 80, the bearing housing 82, and the intermediate plate 84 are fixedly interconnected through suitable fasteners, such as bolts or screws. The shaft 110 is held within the bearing housing 82 by a bearing assembly 104 and an end plate 106.

The adapter body 80 is a generally cylindrical body having a passageway extending coaxially therethrough comprising a receptacle 86 at a first end transitioning to a bore 88, in turn transitioning to an air chamber 90 at a second end. The receptacle 86 receives a standard fitting 62 on the first lubricant line 50 to fluidly couple the lubricant line 50 to the adapter body 80. Extending radially outwardly from the air chamber 90 is an air inlet 92 adapted for receipt of a standard air inlet fitting 64 for fluidly coupling the air line 54 to the air chamber 90 of the adapter body 80.

The bearing housing 82 is a generally annular body having a passageway extending coaxially therethrough comprising a shaft chamber 100 at a first end transitioning radially outwardly to a bearing chamber 102 extending to a second end. Extending radially outwardly from the shaft chamber 100 is an air/lubricant inlet 108 adapted for receipt of a standard air/lubricant inlet fitting 66 for fluidly coupling the air/lubricant line 52 to the bearing housing 82. An annular end plate 106 is fixedly attached to the second end of the bearing housing 82 and encloses the bearing chamber 102.

The intermediate plate 84 is a generally circular plate-like body having a collar 96 extending coaxially from a first face thereof, and forming an enclosing wall for the shaft chamber 100. The collar 96 is adapted for receipt of an O-ring 98 therearound for fluid-tight registry with the air chamber 90.

The shaft 110 is an elongated, somewhat cylindrical body comprising a proximal end 112, transitioning radially inwardly to a bearing section 116, in turn transitioning radially outwardly to a distal end 114. A tube passageway 118 extends coaxially therethrough. The bearing section 116 is adapted for rotational receipt of frictionless bearing assemblies 104 therearound. The bearing assemblies 104 are mounted within the bearing chamber 102 while receiving the bearing section 116 of the shaft 110. In this manner, the shaft 110 can freely rotate within the bearing housing 82. The proximal end 112 is received within the shaft chamber 100, and has a diameter somewhat smaller than the diameter of the shaft chamber 100 to thereby enable the proximal end 112 to freely rotate within the shaft chamber 100. The bearing section 116 extends coaxially through the end plate 106 so that the distal end 114 extends beyond the end plate 106.

Referring also to FIG. 2A, the distal end 114 transitions to a tip 120 having a tip opening 122 extending coaxially therethrough in coaxial registry with the tube passageway 118, and adapted for receipt of a portion of a tube assembly 130.

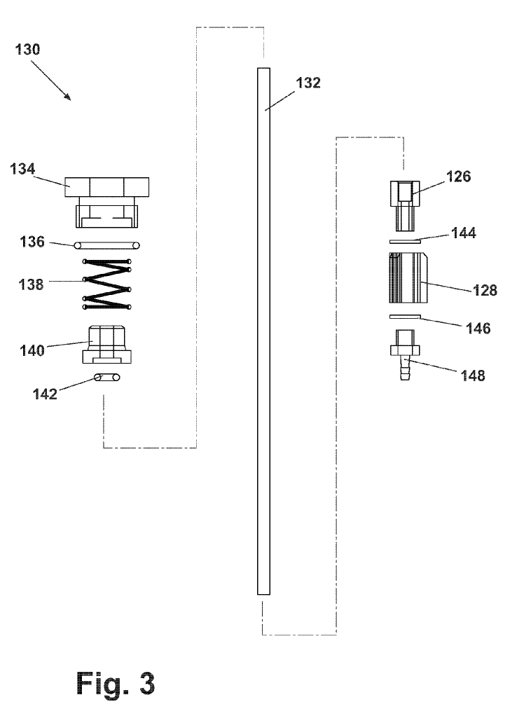

The tube assembly 130 extends through the interior of the rotary coupling 60 and directs a flow of lubricant from the line 50 through the rotary coupling 60. The tube assembly 130 is shown in detail in FIG. 3, and comprises an elongated, hollow tube 132 having one end in fluid communication with the receptacle 86 and another end in the tip opening 122. A spring seat 140 comprising an annular body adapted for slidable receipt of the tube 132 is provided with a channel for receipt of an O-ring 142 therein and circumscribing the tube 132 to seal the tube 132 relative to the spring seat 140. An end cap 134 comprising a threaded body adapted for threadable insertion in the receptacle 86 is adapted for coaxial receipt of the inlet fitting 62 for fluidly coupling the lubricant line 50 to the adapter body 80. An O-ring 136 circumscribes the end cap 134 and is adapted to engage the receptacle 86 when the end cap 134 is threaded into the receptacle 86 for air-tight sealing of the receptacle 86. The O-rings 136 and 142 seal the upstream end of the tube 132 relative to the interior of the receptacle 86. A coil spring 138 is located between the end cap 134 and the spring seat 140 to urge the spring seat 140 toward the air chamber 90.

A nipple fitting assembly mounts to the downstream end of the tube 132 and comprises a tube connector 126, an air separator 128, and a nipple 148. This configuration permits lubricant entering the tube 132 to pass through the interior of the air separator 128 and out the nipple 148 while permitting the air entering the port 92 to pass from the interior of the rotary coupling around the nipple 148.

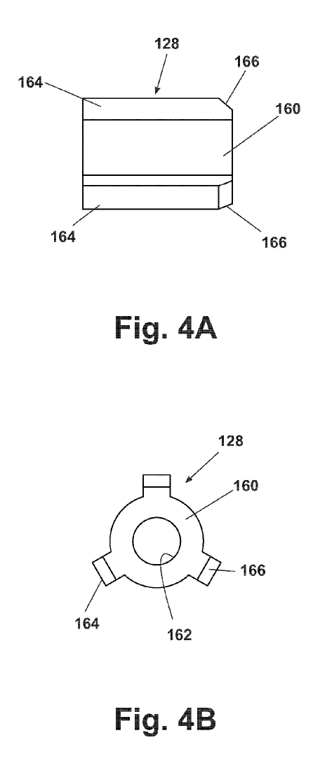

The tube connector 126 is an annular body adapted for frictional receipt of the downstream end of the tube 132. Referring also to FIGS. 4A and 4B, the air separator 128 is a generally annular body comprising an annular wall 160 defining an aperture 162 extending coaxially therethrough. A plurality of longitudinal ribs 164 extend radially outwardly from the annular wall 160, having chamfered shoulders 166 at a first end thereof. As illustrated, the air separator 128 has three ribs 164, although a fewer or greater number of ribs can be used. The air separator 128 is adapted for frictional receipt in the tip opening 122. The air separator 128 is press fit within the tip opening 122 such that the longitudinal ribs bear against the inner surface of the tip to hold the air separator within the tip.

Referring again to FIGS. 2 and 3, the nipple 148 is an annular body adapted for partial frictional receipt in the aperture 162 of the air separator 128 and having an end for frictional insertion into a flexible tubing 72. The tube connector 126 is also adapted for partial frictional receipt in the aperture 162 of the air separator 128. A first washer 144 is provided between the tube connector 126 and the air separator 128, and a second washer 146 is provided between the nipple 148 and the air separator 128.

As described and illustrated, the tube assembly 130 is received within the rotary coupling 60 to extend from the receptacle 86 through the bore 88, the air chamber 90, the aperture 94, the tube passageway 118, and the tip opening 122 beyond the air separator 128, and exit at the nipple 148. Thus assembled, a fluid passageway is configured (arrow A in FIG. 2) extending from the receptacle 86 to join the nipple 148. A lubricant tubing 72 for the spindle 70 is fluidly coupled to the nipple 148 for delivery of lubricant from the lubricant line 50, through the rotary coupling, to the spindle 70. The lubricant tubing 72 extends the length of the spindle 70.

As illustrated in FIG. 2, a standard check valve 1 50 is mounted at the end of the lubricant tubing 72. Alternatively, the check valve 1 50 can be eliminated, and a length of supplemental hypodermic tubing (not shown) having an outer diameter approximately equal to the inner diameter of the lubricating tubing 72 and adapted for frictional receipt in the lubricating tubing 72 can be attached, such as by “push fitting”, to the lubricating tubing 72 for controlling the volume and placement location of the lubricant from the lubricant tubing 72.A through air passage (arrow B in FIG. 2) extends from the air inlet 92 and out the tip opening 122 to permit the air entering from line 54 to be directed out the tip opening 122 by passing around the exterior of the air separator and between the ribs, where it encircles the lubricating tubing 72. The passages defined by arrows A and B independently supply lubricant and pressurized air, respectively, to the spindle 70 through the rotary coupling. The spindle 70 can be configured in a variety of ways to use the lubricant and air. How the spindle is configured is not germane to the invention.

A fluid passageway (arrow C in FIG. 2) is also defined extending from the shaft chamber 100 circumferentially around the proximal end 112 of the shaft 110 into the bearing chamber 102 for delivery of an air/lubricant mixture from the air/lubricant line 52 to the bearing assembly 104. The passage C supplies the pressurized air with entrained lubricant to the bearings and associated seals (not shown).

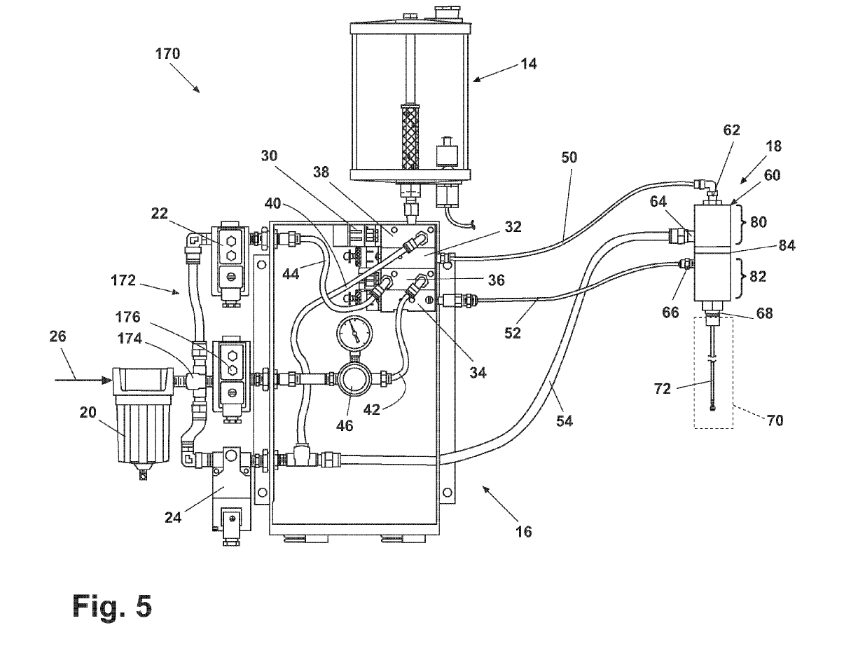

FIG. 5 illustrates a second embodiment of a lubricant delivery system 170 which is similar in many respects to the lubricant delivery system 10, wherein like numerals are used to identify like elements. In general, the system of FIG. 1 continuously supplies air to both lines 52, 54 as long as the valve 24 is open. Thus, it is not possible to independently control the supply of air through lines 52, 54, which might be desirable when the spindle 70 does not require lubricant but the bearings 104 still need lubricating. The embodiment of FIG. 5 permits the independent control of air to the spindle and bearings.

Looking at the structure of FIG. 5 in detail, the lubricant delivery system 170 is provided with an air delivery system 172 wherein the air filter/regulator 20 is fluidly coupled to the electronic time delay 22 and the solenoid 24 as in the lubricant delivery system 10. However, a four-way junction 174 is fluidly coupled to the air filter/regulator 20, the electronic time delay 22, and the solenoid valve 24, plus a second solenoid valve 176. The solenoid valve 24 is fluidly coupled through the air line 54 to the air inlet 64 in the rotary coupling 60, and through the air line 40 to the fluid manifold 38. The electronic time delay 22 is fluidly coupled through the air line 44 to the fluid manifold 36, as in the first embodiment. The second solenoid valve 176 is fluidly coupled to the pressure regulator 46 and then through the air line 42 to the fluid manifold 36. Thus, air to the fluid manifold 36 is supplied through an independent solenoid valve 176 rather than through a solenoid valve 24 that also provides air to the rotary coupler 60 and the fluid manifold 38.

This modification in the air delivery system enables the rotary coupler 60 to be operated with air and lubricant delivered to the bearing assembly 104 and associated seals (not shown) only by operating the electronic time delay 22 and the second solenoid valve 176. Alternatively, operating the first solenoid valve 24 only will provide air and lubricant to the spindle 70 only. Finally, operating the electronic time delay 22, the first solenoid valve 24, and the second solenoid valve 176, will deliver air and lubricant to both the spindle 70 and the bearing assembly 104 and associated seals. Thus, the delivery of lubricant to the rotary coupler 60 can be precisely controlled.

The lubricant and coolant delivery system 10, 110 exemplified in both embodiments enables a single source of pressurized air and a single source of lubricant to serve as both a cutting tool/workpiece lubricating system and a rotary coupling lubricating system. First, as the rotary coupling 60 operates in response to the turning of the spindle 70 and the cutting tool, discrete constant volumes of lubricant are delivered in a pulsed flow through the lubricant line 50, through passage A, and into the lubricant tubing 72 for mixing with the pressurized air flowing from line 50 and exiting from passage B for subsequent mixing in the spindle to a near dry lubricant to the cutting tool/workpiece to cool the tool/workpiece. Second, a mixture of pressurized air and lubricant can also be delivered directly to the bearing assembly 104 in the rotary coupling 60 concurrently with the delivery of air and lubricant to the cutting tool/workpiece. While this air/lubricant mixture can be delivered in discrete pulsed volumes, as illustrated, a steady stream of air is applied to the bearings with an occasional volume of lubricant introduced into the air stream to lubricate the bearings. Given the much lower volume of lubricant that is needed to lubricate the bearings as compared to that needed to cool the tool/workpiece, the lubricant is dispensed at much greater volumes through line 50 than through line 52. Finally, the first embodiment of the lubricant and coolant delivery system 10 continuously supplies air to both lines 52, 54 as long as the valve 24 is open. In contrast, the second embodiment of the lubricant and coolant delivery system 110 enables the independent control of air through the lines 52, 54 to the spindle 70 and bearings 104 by routing the air to the line 54 through the valve 24 and separately routing the air to the line 52 through the valve 176, which might be desirable when the spindle 70 does not require lubricant but the bearings 104 still need lubricating.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A rotary coupling, comprising:
a housing defining a bearing chamber;
a rotatable shaft having a portion located in the bearing chamber and an internal lubricant passageway having an inlet and an outlet, with the inlet configured to receive a lubricant that is expelled through the outlet;
a bearing located within the bearing chamber and disposed between the housing and the shaft to rotatably mount the shaft to the housing; and
a lubricant inlet in the housing and fluidly coupled to the bearing chamber whereby an externally located lubricant can be supplied to the bearing.

2. A rotary coupling according to claim 1, and further comprising a tube forming the internal lubricant passageway.

3. A rotary coupling according to claim 1, wherein the shaft further comprises an internal air passageway having an outlet operably adjacent the outlet of the lubricant passageway such that exiting lubricant is atomized in the air.

4. A rotary coupling according to claim 3, wherein the internal lubricant passageway and the internal air passageway are coaxially disposed.

5. A rotary coupling according to claim 1, and further comprising a lubricant supply remotely-located from the rotary coupling and fluidly coupled to the lubricant inlet.

6. A rotary coupling according to claim 5, wherein the lubricant supply is fluidly coupled to the internal lubricant passageway.

7. A rotary coupling according to claim 5, wherein the lubricant supply comprises an oil.

8. A rotary coupling according to claim 5, wherein the lubricant supply comprises an oil entrained in air.

9. A lubrication system comprising:
a rotary coupling comprising a housing, a bearing in the housing, and a rotating member supported by the bearing in the housing, and configured to deliver fluid from an external fluid source through the rotating member; and a lubricant supply external of the rotary coupling and fluidly coupled to the bearing for delivering a lubricant to the bearing.

10. A lubrication system according to claim 9, wherein the rotating member has an internal lubricant passageway therethrough having an inlet and an outlet, with the inlet configured to receive a lubricant that is expelled through the outlet.

11. A lubrication system according to claim 10, wherein the rotating member further comprises an internal air passageway.

12. A lubrication system according to claim 11, wherein the internal lubricant passageway and the internal air passageway are coaxially disposed.

13. A lubrication system according to claim 11 wherein the internal air passageway has an inlet in the housing radially disposed relative to the rotating member.

14. A lubrication system according to claim 9, wherein the lubricant comprises an oil.

15. A lubrication system according to claim 9, wherein the lubricant comprises a near dry lubricant.

16. A lubrication system according to claim 1 5, wherein the near dry lubricant comprises oil entrained in air.

17. A lubrication system according to claim 9, and further comprising a valve system operably coupling at least one of the rotating member and the bearing to the lubricant supply.

18. A lubrication system according to claim 17, wherein the valve system selectively couples the one of the rotating member and the bearing to the lubricant supply.

19. A lubrication system according to claim 17, wherein the valve system comprises a single valve coupling both the rotating member and bearing to the lubricant supply.

20. A lubrication system according to claim 17, wherein the valve system comprises a separate valve for coupling each of the rotating member and the bearing to the lubricant supply.

21. A lubrication system according to claim 17, and further comprising a metering system fluidly coupled to the lubricant supply and the rotary coupling for controlling the delivery of lubricant to at least one of the bearing and the rotating member.

22. A lubrication system according to claim 21, wherein the metering system comprises a pulsatory control apparatus for delivering discrete doses of lubricant to the bearing.

23. A lubrication system according to claim 21, and further comprising an air system for delivering pressurized air to at least one of the bearing and the rotating member.

24. A lubrication system according to claim 23, wherein metering system and air system are fluidly coupled such that the lubricant is entrained within the pressurized air when it is delivered to the bearing.

25. A method for lubricating a rotary coupling comprising a housing defining a bearing chamber, a shaft having a portion located in the bearing chamber, and a bearing located within the bearing chamber and disposed between the housing and the shaft to rotatably mount the shaft to the housing, the method comprising:
lubricating the bearing while the shaft is rotated.

26. A method according to claim 25, and further comprising delivering a lubricant through the shaft.

27. A method according to claim 26, wherein the step of delivering a lubricant through the shaft comprises delivering one of a coolant and a lubricant through an internal lubricant passageway in the shaft.

28. A method according to claim 27, and further comprising lubricating the bearing independently of delivering the one of the coolant and the lubricant through the shaft.

29. A method according to claim 28, and further comprising simultaneously lubricating the bearing and delivering the one of the coolant and the lubricant through the shaft.

30. A method according to claim 29, wherein the lubricating of the bearing comprises lubricating the bearing with a near dry lubricant.

31. A method according to claim 30, wherein the lubricating of the bearing with a near dry lubricant comprises lubricating the bearing with an oil entrained in a stream of air.

32. A method according to claim 31, wherein the entraining of oil in the stream of air comprises selectively introducing oil into the stream of air.
